(19) United States
(12) Patent Application Publication
(10) Pub. No.: US 2007/0164557 A1
(43) Pub. Date: Jul. 19, 2007

(54) Identification means

(75) Inventor: Alistair Oakes, Milton Keynes (GB)

Correspondence Address: WINSTEAD SECHREST & MINICK P.C., PO BOX 50784, DALLAS, TX, 75201, US

(73) Assignee: Ivy Trust, Geneva (CH)

(21) Appl. No.: 10/552,495

(22) PCT Filed: Apr. 6, 2004
(86) PCT No.: PCT/IB04/01465

§ 371 Date: Oct. 25, 2006

(30) Foreign Application Priority Data
Apr. 7, 2003 (GB) 0307980.3

(51) Int. Cl. H04L 9/00; H04K 1/00

(52) U.S. Cl. 283/74

(57) ABSTRACT

Identification means are provided which include a first identification portion in the form of one or more images, characters and/or text. A second identification portion is removably located with said first identification portion to at least partially mask the first identification portion until the second identification portion is removed. The second identification portion is also in the form of one or more images, characters and/or text.

### CROSS REFERENCE TO RELATED APPLICATION

This application is a 371 National Phase of PCT/IB2004/001465 filed on 06 Apr. 2004 which claims priority to GB 0307980.3 filed on 07 Apr. 2003.

### FIELD OF INVENTION

This invention relates to identification means, and particularly but not necessarily exclusively to identification means for use with security related data.

### BACKGROUND OF INVENTION

Although the following description refers almost exclusively to identification means provided on or in the form of a phone card, it will be appreciated by persons skilled in the art that the identification means can be used in relation to any article for a variety of applications where a number, image or text is required to remain confidential or hidden for a predetermined period of time, such as for example, a scratch card, a promotional game, a lottery card or a brand protection process.

Many conventional phone cards are provided with an identification portion thereon, such as a pin number or recharge number, which needs to be activated by dialling a third party in order for a user to use the phone card and obtain phone credits associated with the card. The phone credits are typically pre-paid for by the user. If this pin number were to become available to an unscrupulous third party without payment of the phone card, then the phone credits could be used without the phone network supplier receiving any revenue and/or a user having paid for a phone card on which phone credits have already been used. It is therefore important for the pin number of the card to remain secure and typically masked from third parties until such a time when the phone card has been legitimately purchased by a user.

Conventional security measures which are used to mask the pin number or identification portion include providing an abradable coating, such as a thick latex coating, holographic material usually applied directly over the recharge number or by applying a scratch label containing one of the above over the pin number to hide the same from view until the abradable coating has been irreversibly removed by scratching or rubbing the same off the card using a coin, fingernail or similar. If the abradable coating has been removed from the card prior to purchase, it is immediately evident to a user that the card has been tampered with, possibly as a result of fraudulent actions. Other security measures include providing the phone card with an opaque core and/or providing the area beneath the pin number with an opaque layer or blocking layer.

However, problems associated with conventional security measures are that the pin number or identification portion may be exposed for lengthy periods of time during manufacture, thereby allowing a third party to gain access to the pin number prior to the abradable coating being applied over the same, which is a security risk. A number of process steps may be applied to the pin number or card in order to increase the masking of the number but these processes typically increase the time taken for manufacturing the phone card and thus the cost of the card.

It is therefore an object of the present invention to provide identification means which can be manufactured both quickly and easily and which reduces the risk of fraudulent decipherment of one or more portions of information or identification data thereon.

### SUMMARY OF INVENTION

According to a first aspect of the present invention there is provided identification means, said identification means including a first identification portion relating to data of a secure or confidential nature in the form of one or more images, characters and/or text, a second identification portion removably located with at least a part of said first identification portion to at least partially mask the first identification portion until said second identification portion has been removed therefrom, said second identification portion also being in the form of one or more images, characters and/or text, and wherein the second identification portion is provided in overlapping relationship with a whole or substantial part of said first identification portion so that the combination of the first and second identification portions forms a further one or more images, characters and/or text different in appearance to said first and second identification portions, the first and second identification portions being undecipherable from the further one or more images, characters and/or text until the second identification portion has been removed.

The terms “images, characters and/or text” refers to any picture, graphics, symbol, shape, numbers, writing, letters, logo and/or the like which can be used to convey pre-determined information or data.

Preferably the second identification portion is formed from an abradable material which is irreversibly removable from the first identification portion, typically by scratching or rubbing of the same with a coin or fingernail.

Preferably the second identification portion is located with a whole or substantial part of said first identification portion.

The first identification portion typically only becomes visible to a user on removal of the second identification portion.

The second identification portion can be provided under or below the first identification portion. However, in a preferred embodiment the second identification portion is provided on top of or above the first identification portion.

The first identification portion can be provided on a surface or base of the identification means. This base or surface can be opaque or transparent. The second identification means can be provided on top of the first identification portion, under the first identification portion. Any further removable layers or identification portions can then be provided on either the first and second identification portions as required.

The second identification portion is preferably different in appearance to the first identification portion. For example, if the first identification portion is in the form of a plurality of numbers, the second identification portion can also be in the form of a plurality of numbers. However, each overlapping number of the first and second identification portions is typically different. As such, the text, characters and/or images of the first identification portion are typically misaligned relative to those of the second identification portion to create a further image, character and/or text which is different in appearance to said first and second identification portions.

In one embodiment at least one further removable portion or coating is applied over at least a part of said first and second identification portions. In a preferred embodiment the removable coating is applied over the whole or a substantial part of said first and second identification portions.

Preferably the further removable coating includes one or more layers of abradable material. The removable coating can be formed from the same or different material to that of the second abradable identification portion and can be applied by the same or different methods.

In a further embodiment at least a third identification portion is provided on said removable coating. The third identification portion is typically clearly visible to a user viewing the identification means.

Preferably the third identification portion relates to or is associated with one or more images, characters and/or text provided on the identification means. These are typically separate to and/or independent of the first and/or second identification portions. The third identification portion typically provides a fingerprint or code unique to each particular article or identification means.

Preferably the third identification portion is formed from abradable material and is visibly distinguishable to a user from the abradable material of the removable coating.

The abradable material on the identification means which form the different identification portions and/or removable layers can be different and/or formed so that each layer has to be removed separately using different levels of abrasive force. Alternatively, the removable layers or portions can be removed substantially simultaneously.

The identification means can be any or provided on any of a carrier, telephone card, promotional game, ticket, pin card, label, scratch card, lottery card, brand protection process and/or the like. The identification means can be provided alone or can be attached to, integrally formed with or associated with one or more other articles. For example, if a drinks manufacturer were to run a joint marketing campaign with a phone network, the phone network could provide the drinks manufacturer with identification means for locating on their drink containers. The consumer of the drinks container could then reveal the first identification portion by scratching off the abradable coatings associated with the second of further abradable coatings to see if they have won a prize, telephone credits and/or the like.

Attachment means can be provided with the identification means to allow the same to be attached to one or more articles or surfaces. For example, the attachment means can include one or more clips, adhesive and/or the like. In the case of adhesive, the layer of adhesive can be provided on a front and/or rear surface of the identification means.

Preferably the first identification portion is in a substantially permanent form, such as in the form of an ink applied to a suitable surface or carrier by a printing process.

In one embodiment fluorescent ink can be used if required.

Further preferably the first identification means is in the form of a pin number, recharge number or security code which needs to be masked from the view of third parties until a point in time when a user wishes to see or reveal the number or security code.

Preferably the method of forming the identification means of the present invention or at least the method for applying the first and further identification portions/coatings thereon can be undertaken substantially simultaneously, thereby increasing the speed and ease of manufacture of the same and reducing the cost associated with manufacturing. For example, in the present invention each of the identification portions and/or coatings can be laid down on the surface of an article in approximately 0.12 seconds. As such, the risk of visual exposure of the first identification portion during manufacture is prevented or at least greatly reduced.

Preferably a holographic image or other security means is provided in association with the identification means. The clear holographic image and/or other security means are typically provided over the abradable coating and/or third identification portion.

According to a second aspect of the present invention there is provided a method of manufacturing identification means, said method including the steps of providing a first identification portion relating to data of a secure or confidential nature on a base member, providing a second identification on the base member in overlapping relationship to said first identification portion to cover at least a part of said first identification portion so that the combination of the first and second identification portions forms a further one or more images, characters and/or text different in appearance to said first and second identification portions, said first and second identification portions in the form of one or more images, characters and/or text, the first and second identification portions being undecipherable from the further one or more images, characters and/or text until said second identification portion is removed from said first identification portion.

In a further aspect of the present invention there is provided identification means and a method of manufacturing thereof for providing a first abradable material over at least a part of a second abradable material. The first abradable material is typically visually distinguishable from the second abradable material, such as for example, the first abradable material can be in the form of an image, text and/or one or more characters and the second abradable material can be in the form of a substantially uniform coating layer.

According to a yet further aspect of the present invention there is provided identification means, said identification means including a first identification portion in the form of one or more images, characters and/or text, a first abradable coating provided over at least a part of the first identification means to at least partially mask the first identification portion, and wherein a second abradable coating is provided over at least a part of said first abradable coating.

Preferably the first abradable coating is visually distinguishable from the second abradable coating. Further preferably the first abradable coating relates to or is associated with other data provided on the identification means, and the data is typically unique to said identification means.

According to a yet further aspect of the present invention there is provided a method of allowing a user to verify the authenticity of identification means, said identification means including a first identification portion in the form of one or more images, characters and/or text and a second identification portion removably located with at least a part of said first identification portion to at least partially mask the first identification portion until said second identification portion has been removed therefrom, said second identification portion also being in the form of one or more images, characters and/or text, said method including the steps of a user removing said second identification portion to reveal the data in said first identification portion, the user contacting database means and providing the first identification portion data to said database means, said database means checking the revealed first identification portion data against known data and providing confirmation to the user that the identification means is authentic if the revealed first identification portion data matches said known data.

The advantage of the present invention is that the identification means includes a number of security measures provided over the first identification portion in the form of second or further abradable layers, thereby providing increased security and a reduction in the risk of fraud and/or illegal copying associated with the same. The first identification portion cannot be read without removing the removable layers. As such, if the user detects tampering of the removable layers, they will know that the first identification potion may have been seen by an unauthorised third party. The present invention is resistant to low technical criminal activities for unauthorised visualisation of the first identification portion, such as the use of sello-tape, razor blades, freezing, pulling off of layers and/or the like.

The identification means of the present invention is difficult to counterfeit since each label, article comprising the identification means is given a unique appearance which cannot be mass produced. The first and second identification portions are typically randomly computer generated.

### BRIEF DESCRIPTION OF THIE DRAWINGS

The foregoing summary as well as the following detailed description of the preferred embodiment of the invention will be better understood when read in conjunction with the appended drawings. It should be understood, however, that the invention is not limited to the precise arrangements and instrumentalities shown herein. The components in the drawings are not necessarily to scale, emphasis instead being placed upon clearly illustrating the principles of the present invention. Moreover, in the drawings, like reference numerals designate corresponding parts throughout the several views.

The invention may take physical form in certain parts and arrangement of parts. For a more complete understanding of the present invention, and the advantages thereof, reference is now made to the following descriptions taken in conjunction with the accompanying drawings, in which

FIGS. 1a-1d illustrate four stages of manufacturing a phone card according to one embodiment of the present invention.

### DETAILED DESCRIPTION OF THE INVENTION

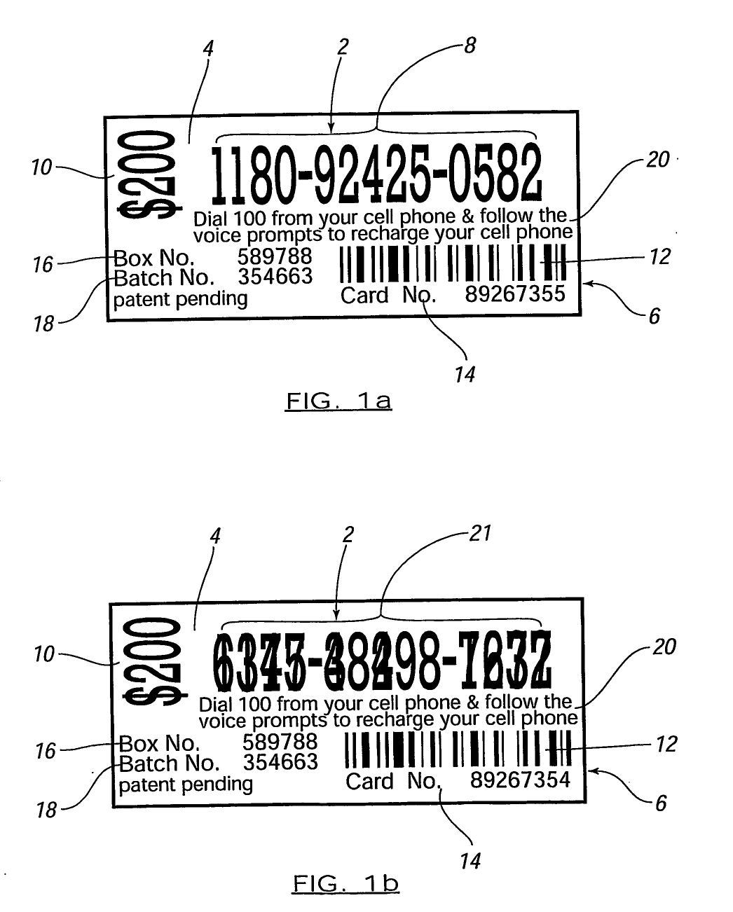

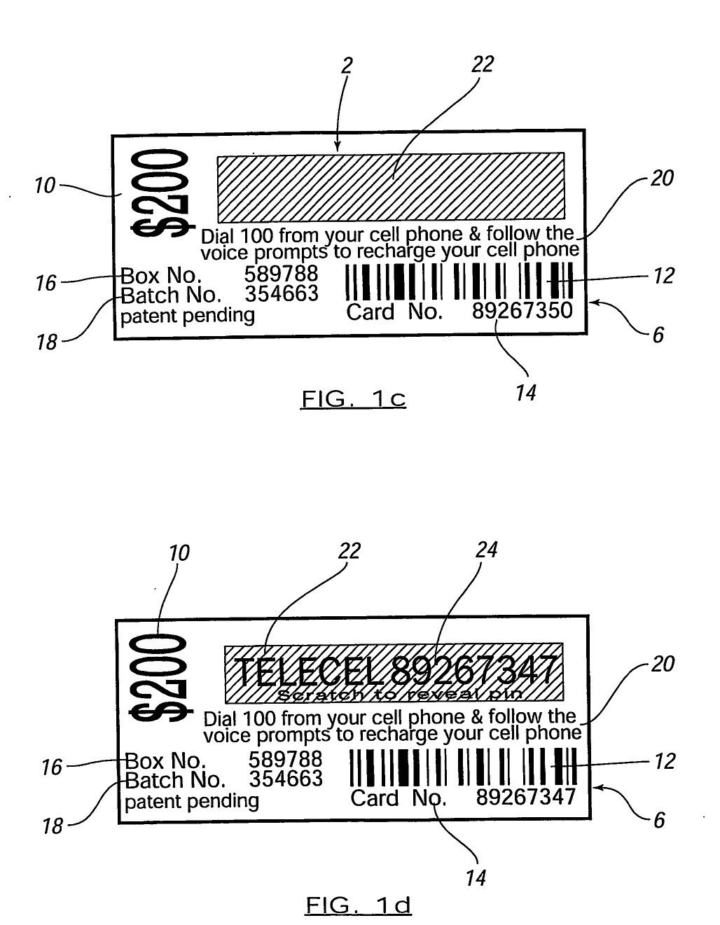

Referring firstly to FIG. 1a, there is illustrated identification means 2 according to one example of the present invention in the form of a phone card 6.

The identification means 2 includes a first identification portion in the form of a 13 digit pin number identified by reference numeral 8 which is applied to surface 4 of the phone card 6. Surface 4 of phone card 6 also includes data relating to the price of the phone card 10, which in this example is $200, a bar code 12, a card number 14, a box number 16, a batch number 18 and text instructions 20 to allow a user to use the phone card. The other data on the phone card can be used to allow a user to verify the authenticity of the card as described in more detail below. This other data can be read directly by the user without the requirement for removing any security means, such as abradable material therefrom. Alternatively, security means, such as abradable material can be provided over this other data.

The pin number 8 is confidential and therefore needs to be hidden from view from third parties until a user purchases the phone card, thereby preventing fraudulent use of the pin number by third parties.

In accordance with the present invention a second identification portion 21 in the form of a different 13 digit number is located over the pin number 8, as shown in FIG. 1b. With the numbers/identification portions provided in this overlapping arrangement, it is difficult if not impossible for a third party to decipher the pin number 8 from the number comprising the second identification portion 21. This is because the first and second overlapping numbers provide a new third image, the components of which can not be deciphered.

The second identification portion is formed from an abradable material which can be scratched off by a user to reveal the pin number 8 once the user has purchased the phone card 6.

In order to further mask the pin number 8, a removable coating 22 is provided over substantially the whole of pin number 8 and second identification portion 21, as shown in FIG. 1c. Coating 22 is also formed from an abradable material which can be scratched off by a user, and typically substantially simultaneously to the scratching off of the second identification portion, to reveal pin number 8.

In a final and typically optional step, a unique identification code 24 is applied over the top of removable coating 22 and is visible to a user, as shown in FIG. 1d. This unique identification code typically corresponds to other visible data provided on phone card 6, which in this example is the card number 14. As such, the user has an easy reference to confirm authenticity of the phone card without requiring contact with the manufacturer or supplier. The identification code 24 is formed from an abradable material which is removable from the card on removal of coating 22 and the second identification portion.

The identification code 24 is unique to the phone card 6 in question (i.e., it provides a unique fingerprint for each card). As such, a third party cannot simply manufacture batch loads of fraudulent cards because this unique code will be different for each card. This is different to prior art cards, wherein the same static image or code is provided for an entire batch or production run of cards, thereby making it relatively easy for a third party to copy entire batches of cards in a single manufacturing process. This is not the case with the present invention.

The abradable material used in the present invention is typically of a type used in the production of thermally printed labels, such as bar code label production.

The abradable material is formed such that the adhesive bond formed between the first identification portion and the further abradable coatings/ layered applied thereto is sufficiently weak to allow removal of the same on scratching. Scuff testing has been performed on the abradable material used in the present invention and it has been found that very little deterioration of the abradable material occurred during the test, thereby indicating that it is unlikely that the abradable material would be accidentally removed by simply rubbing up against the surface of another article or surface.

In one embodiment, the method by which the first identification portion and the layers of abradable material are applied to the article or phone card include the use of a combination of different types of thermal ribbon. Thermal ribbons are formulated as resin, wax or resin and wax. The first resin layer is substantially permanent when applied to the surface of an article and can, for example, be used for the first identification portion. The combination of wax and resin layer is less permanent and can be removed from the surface of the first resin layer when applied thereto and can, for example, be used for the second identification portion. The wax layer is not permanent at all and can be easily removed and so can be used for the further removable layer and/or third identification portion. The wax layer can be removed prior to the removal of the wax and resin layer or at the same time.

The identification means of the present invention has undergo rigorous testing to determine whether the first identification portion can be deciphered or viewed without removal of the one or more coating layers applied thereto. This testing provides an indication as to the ease by which the identification means could be fraudulently reproduced and includes use of light or lasers which are shone behind the card on which the identification means is provided, x-ray which attempts to identify any optical change in the ink or printing used to provide the first identification portion, atomic force or electron microscopy which is used in an attempt to measure changes in the surface of the card or identification means in a three dimensional manner, ultransonics, ultraviolet light and thermal imaging. None of the tests undertaken on the identification means of the present invention allow visualisation of the first identification portion without removal of the one or more abradable coatings or layers, thereby proving that the identification means of the present invention provides increased security whilst reducing the time and costs taken to manufacture the same.

In a further embodiment of the present invention, a method is provided by which a user can verify whether the identification means, such as a card or label attached to a product, they have in their possession is authentic or whether it has been fraudulently produced. This method involves the user scratching off one or all of the abradable layers to reveal the first identification portion, which in this example is in the form of a pin number. The user then contacts a service centre which has a database of all the authentic pin numbers provided by the manufacturers of the card or label attached to a product and communicates the pin number revealed to the service centre. The database is searched to determine whether the revealed pin number matches the manufacturers pin numbers and, if it does, this proves the card or label attached to a product is authentic. The user is informed of this and therefore has the knowledge that the product is carrying a genuine identification card or label and is therefore likely to be a genuine product. This communication is typically very rapid, thereby providing the user with almost instant verification.

The user and the service centre can communicate with each other by any known form of communication, such as telephone, letter, e-mail, text message and/or the like.

The database can include information such as the location and date on which the identification means was manufactured, the dealers the identification means was shipped to, the product onto which the means was attached, the date of shipment, first identification portion data, second identification portion, third identification portion data, bar code data, batch number, box number, card number and/or the like.

It will be appreciated by persons skilled in the art the invention can include any or any combination of the above described features. In addition, a plurality of scratch panels, first and second identification portions and/or the like can be provided on the identification means as required.

Although the invention has been described with reference to specific embodiments, these descriptions are not meant to be construed in a limiting sense. Various modifications of the disclosed embodiments, as well as alternative embodiments of the invention will become apparent to persons skilled in the art upon reference to the description of the invention. It should be appreciated by those skilled in the art that the conception and the specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims.

It is therefore, contemplated that the claims will cover any such modifications or embodiments that fall within the true scope of the invention

1. Identification means, said identification means including a first identification portion in the form of one or more images, characters and/or text and wherein a second identification portion is removably located with at least a part of said first identification portion to at least partially mask the first identification portion until said second identification portion has been removed therefrom, said second identification portion also being in the form of one or more images, characters and/or text.

2. Identification means according to claim 1 wherein the first identification portion includes data of a secure or confidential nature.

3. Identification means according to claim 1 wherein the second identification portion is provided in overlapping relationship with said first identification portion.

4. Identification means according to claim 1 wherein the combination of said first and said second identification portions forms a further one or more images, characters and/or text different to said first and second identification portions.

5. Identification means according to claim 1 wherein the second identification portion is formed from an abradable material which is irreversibly removable from the first identification portion.

6. Identification means according to claim 1 wherein the second identification portion is located with a whole or substantial part of said first identification portion.

7. Identification means according to claim 1 wherein the second identification portion is provided under or below the first identification portion.

8. Identification means according to claim 1 wherein the second identification portion is provided on top of or above the first identification portion.

9. Identification means according to claim 1 wherein the second identification portion is different in appearance to the first identification portion.

10. Identification means according to claim 1 wherein at least one further removable portion or coating is applied over at least a part of said first and/or second identification portions.

11. Identification means according to claim 10 wherein the at least one further removable portion or coating is applied to a whole of substantial part of said first and second identification portions.

12. Identification means according to claim 10 wherein the further removable portion includes one or more layers of abradable material.

13. Identification means according to claim 10 wherein at least a third identification portion is provided on the further removable portion.

14. Identification means according to claim 13 wherein the third identification portion is visible to a user viewing the identification means.

15. Identification means according to claim 13 wherein the third identification portion relates to or is associated with one or more images, characters and/or text provided on the identification means.

16. Identification means according to claim 15 wherein the one or more images, characters and/or text are separate to and/or independent of said first and/or second identification portions.

17. Identification means according to claim 13 wherein the third identification portion is formed from abradable material.

18. Identification means according to claim 1 wherein the identification means are any of a carrier, telephone card, promotional game, ticket, pin card, label, scratch card, brand protection process or lottery ticket.

19. Identification means according to claim 1 wherein the identification means is provided with attachment means for attaching the same to an article.

20. Identification means according to claim 19 wherein the attachment means includes an adhesive provided thereon.

21. Identification means according to claim 1 wherein the first identification portion is printed onto the identification means.

22. Identification means according to claim 1 wherein at least the first and second identification portions are applied to the identification means substantially simultaneously during manufacture.

23. Identification means according to claim 1 wherein a holographic image is provided on said identification means.

24. Identification means according to claim 1 wherein the first identification portion includes a resin containing material.

25. Identification means according to claim 1 wherein the second identification portion includes a resin and wax containing material.

26. Identification means according to claim 10 wherein the further removable portion includes a wax containing material.

27. A method of manufacturing identification means, said method including the steps of providing a first identification portion on a base member, providing a second identification on the base member to cover at least a part of said first identification portion, said first and second identification portions in the form of one or more images, characters and/or text, the first identification portion being masked, at least in part, by said second identification portion until said second identification portion is removed therefrom.

28. A method of allowing a user to verify the authenticity of identification means, said identification means including a first identification portion in the form of one or more images, characters and/or text and a second identification portion removably located with at least a part of said first identification portion to at least partially mask the first identification portion until said second identification portion has been removed therefrom, said second identification portion also being in the form of one or more images, characters and/or text, said method including the steps of a user removing said second identification portion to reveal the data in said first identification portion, the user contacting database means and providing the first identification portion data to said database means, said database means checking the revealed first identification portion data against known data and providing confirmation to the user that the identification means is authentic if the revealed first identification portion data matches said known data.
